(19) United States
(12) Patent Application Publication
(10) Pub. No.: US 2015/0054933 A1
(43) Pub. Date: Feb. 26, 2015

(54) MOTOR VEHICLE WITH MULTIFUNCTIONAL DISPLAY INSTRUMENT

(71) Applicant: GM GLOBAL TECHNOLOGY OPERATIONS LLC, Detroit, MI (US)

(72) Inventors: Dennis Wasiek, Wiesbaden (DE); Torsten Kanning, Eltville-Erbach (DE); Carsten Neitzke, Hessen (DE); Justus Illium, Mainz (DE); Thomas Schramm, Mainz (DE)

(21) Appl. No.: 14/469,422

(22) Filed: Aug. 26, 2014

(30) Foreign Application Priority Data
Aug. 26, 2013 (DE) 102013014210.5

(51) Int. Cl. B60R 1/12; G09G 5/12; H04N 5/232

(52) U.S. Cl. CPC B60R 1/12; H04N 5/23216; G09G 5/12; B60R 2001/1253; B60R 2001/1215; B60R 2300/207; B60R 2300/8006; G09G 2380/10
USPC 348/77

(57) ABSTRACT

A display instrument for a vehicle is arranged on a dashboard in combination with a camera configured to be directed at least temporarily to an occupant of the vehicle. The display instrument is able to be switched from a display state for one or several operating parameters of the vehicle into a reproducing state for images delivered from the camera.

### CROSS REFERENCE TO RELATED APPLICATION

This application claims priority to German Patent Application No. 102013014210.5 filed Aug. 26, 2013, which is incorporated herein by reference in its entirety.

### TECHNICAL FIELD

The technical field relates to a vehicle with a display instrument arranged on a dashboard and with a camera which configured to be directed at least temporarily to an occupant of the vehicle.

### BACKGROUND

Such a vehicle is known from EP 0 836 965 B1. In this conventional vehicle, after the omission of a fold-down sun visor, the vanity mirror which is conventionally arranged in such a sun visor is to be replaced by a screen, which is arranged at the upper edge of the windshield where conventionally the interior rearview mirror is mounted. So that this screen can undertake the functions both of the interior rearview mirror and also of the vanity mirror, two cameras are necessary, one directed to the front passenger, which enables him to use the vanity mirror function, and a camera arranged in the rear region of the vehicle and capturing the situation behind the vehicle, which enables the driver to use the screen as a rearview mirror. Despite the greatly reduced costs for electronic cameras and screens in recent years, the replacement of two mirrors by two cameras and a screen still entails considerable additional costs.

### SUMMARY

In accordance with the present disclosure a vehicle is provided in which the replacement of the conventional optical vanity mirror by electronic imaging systems is possible with lower costs. In particular, a display instrument is arranged in a conventional manner on a dashboard and with a camera configured to be directed at least temporarily to an occupant of the vehicle. The display instrument can be switched from a display state for one or more operating parameters of the vehicle into a reproducing state for images delivered from the camera.

In many modern vehicles, the analog needle display instruments which have been usual for decades for the vehicle speed, engine speed etc. are in any case replaced by display instruments of the screen type, which are able to display freely programmable image contents and which, instead of a physically movable needle and a stationary scale only reproduce images of a needle and scale and thus simulate the appearance of conventional analog scale instruments. Such a display instrument is readily able to be used for reproducing the images delivered from the camera, without costs being incurred thereby for additional hardware.

In order to display to an occupant of the vehicle a natural image of him or her, the camera should be arranged adjacent to the display instrument; in particular its distance from the display instrument should be not greater than its screen diagonal.

The display instrument can be arranged in front of a driver's seat; i.e. the operating parameters displayed in the display state can be, in particular, those which are conventionally displayed on a display instrument arranged in front of the driver and relate to the movement of the vehicle, the operation of the engine etc., in particular speed, engine speed, fill levels of operating medium tanks etc. The display instrument can also be arranged on a center console, so that it can also be seen and used in particular by a front passenger. Such a display instrument can serve in the display state in particular for the display of operating parameters of an infotainment system, a heating and/or air-conditioning system of the passenger compartment.

Provision can be made that the reproducing state is only able to be activated when the vehicle is stationary or on falling below a threshold speed of the vehicle. This is expedient in particular when the reproducing state can be used by the driver, because the latter, during normal travel, should be able to take note of the operating parameters of the vehicle unimpeded, which are displayed in the display state, or respectively a distraction of the driver by the reproducing state is to be ruled out during normal travel.

The reproducing state can be activatable by actuation of a switch. On account of intuitive operability, such a switch should be arranged on the dashboard adjacent to the display instrument. In order to save space for such a switch, other ways for activating the reproducing state may be preferred. When an occupant directs the camera to himself, this is a reliable indication that he wishes to use the reproducing state, and can therefore be used as a reason for switching over into the reproducing state. The switching over can also take place even earlier, when the occupant merely touches the camera. In this case, the camera does not even have to be directable onto the one or other occupant, which obviously reduces considerably the expenditure for the installation of the camera.

An image processing unit can be connected between the camera and the display instrument, which image processing unit is arranged to identify the head of the occupant and to emit to the display instrument an image section which contains the head. This is expedient in particular when the camera is not directable or respectively when it has a large field of view, in which the occupant's head would appear too small in order to show details if this field of view were reproduced completely on the display instrument.

The field of view of the camera can be dimensioned in particular far enough in order to capture several occupants, in particular the driver and front passenger. The image processing unit should then be arranged to select one of the occupants, in order to display his head in the image section.

Such a selection can be based for example on a switch for activating the reproducing state being assigned to each occupant and on the image processing unit selecting one or other of the occupants depending on which of the switches has been actuated. On activation by directing the camera, the selection can depend on the direction in which the camera has been pivoted; in the case of touching the camera, a differentiation can be made according to the side which has been touched.

According to a further developed embodiment, the image processing unit is arranged to detect an activation gesture by the occupant and, on detection of the activation gesture, to activate the reproducing state. Here, if the field of view of the camera includes several occupants, the head of the occupant who has carried out the activation gesture can be selected for display. For example, an approach towards the display instrument or, preferably, towards the camera, comes into consideration as activation gesture.

The camera and display instrument can be part of an in-vehicle video conference system. For this purpose, the at least one camera or one of several cameras of the system is to be arranged in order to capture an occupant on a rear seat of the vehicle. In addition, at least one screen allocated to rear seats of the vehicle can be able to be supplied with images which are received from a camera which is directed to the driver and/or front passenger. The video conference system can, in addition, include several microphones for identifying a speaker from amongst the occupants, and a decision unit which is arranged to identify the image of the speaker and to emit it to the display instrument and, if applicable, to the screen.

Further features of the present disclosure will emerge from the following description of example embodiments with reference to the enclosed figures.

### BRIEF DESCRIPTION OF THE DRAWINGS

The present disclosure will hereinafter be described in conjunction with the following drawing figures, wherein like numerals denote like elements.

FIG. 1 shows a diagrammatic view into the interior of the passenger compartment of a vehicle according to the present disclosure; and

FIG. 2 shows a block diagram of a video conference system.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

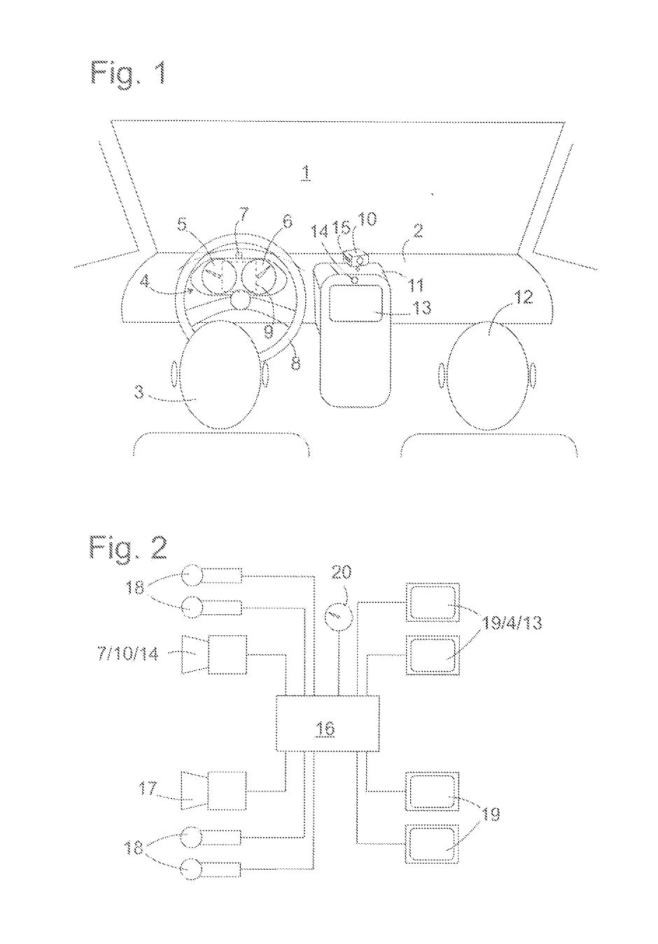

FIG. 1 shows in a diagrammatic view the passenger compartment of a motor vehicle according to the present disclosure with a windshield 1 and a dashboard 2 extending beneath the windshield 1. A combination display instrument 4 is arranged on the dashboard 2 in front of the seat of a driver 3. The combination display instrument 4 has a matrix screen, on which two needle instruments 5, 6, typically for displaying vehicle speed and engine speed, and further smaller display instruments are presented. At the upper edge of the display instrument 4 a camera 7 is inserted into the dashboard 2. Through an opening of a steering wheel 8, the camera 7 has a free view onto the face of the driver 3.

The camera 7 can be part of an assistance system which, by means of images which the camera 7 delivers of the face of the driver 3, in particular by means of a monitoring of his eye movements, assesses the degree of attentiveness of the driver 3 and, in the case of attentiveness which is assessed to be insufficient emits a warning, e.g. by overlaying a display on the display instrument 4, which asks the driver 3 to interrupt the journey.

When the speed of the vehicle lies below a threshold value, preferably only when the vehicle is stationary, the display instrument 4 is able to be switched from a normal operating state or display state, in which it presents the needle instruments 5, 6, into a reproducing state for images delivered from the camera 7. The entire area of the display instrument 4 is not required here for the reproducing of these images—a rectangle in dashed lines in FIG. 1 designates a region 9 of the display instrument 4, in which the image of the camera 7 overlies the presentations of the needle instruments 5, 6, so that the driver's own mirror reflection is indicated to the driver 3 in this region 9.

In the simplest case, the complete image registered by the camera 7 is reproduced in the region 9. In order to be able to display the mirror reflection at a satisfactory size in this case, the view field of the camera 7 should be restricted closely to the head of the driver. If, however, the driver is not sitting centrally, is unusually tall or unusually short, in such a case the possibility exists that the camera 7 does not completely capture the driver's head. In order to remedy this problem, it would come into consideration to replace the camera 7 inserted into the dashboard 2 by a freely and pivotably mounted camera 10, as is shown in FIG. 1 on a center console 11 of the dashboard 2.

However, it is more comfortable for the driver if between the camera 7 and display instrument 4 an image processing unit is included (not illustrated in FIG. 1), which is able to identify the head of the driver 3 in the images delivered from the camera 7, and respectively to emit to the display instrument 4 for reproduction in the region 9 only a section of these images which contains the head. Since, in this case, the camera 7 does not have to be directable, the installation of the camera 7 is possible simply and economically.

The switching of the display instrument 4 into the reproducing state can take place in various ways. Thus, for this purpose, a switch can be provided on the dashboard 2. In particular, the switch can be formed by a touch sensor in the immediate vicinity of the display instrument 4 or of the camera 7, beneath the display instrument 4 is itself constructed as a touch-sensitive screen, which on touching, and in particular of the region 9, reacts by switching into the reproducing state.

In order to switch back into the display state, the same switch can be touched again; however, it is also conceivable to switch back into the display state respectively after a waiting period or on exceeding the threshold speed.

The view field of the camera 7 could be basically wide enough in order to also capture a front passenger 12, so that the image processing unit if required could also emit to the display instrument 4 an image section with the head of the front passenger 12. However, it could be irritating for the driver 3 if the mirror reflection of the front passenger 12 suddenly becomes visible on the display instrument 4. In addition, the display instrument 4 is poorly visible for the front passenger 12 in certain circumstances. In order to also enable the front passenger 12 to use a vanity mirror function, therefore by means of an alternative embodiment of the present disclosure, also illustrated by means of FIG. 1, a display instrument 13 is used for image reproduction, which thanks to its placing on the center console 11 is equally visible for driver 3 and front passenger 12.

The display instrument 13 usually serves for the displaying of parameters of the vehicle which are relevant for driver and front passenger or respectively can also be manipulated by the front passenger if applicable, without this having an influence on the movement of the vehicle, in particular operating parameters of a heating, ventilation or air-conditioning system of the vehicle or of an infotainment system. It can therefore be co-used at a favorable cost for the purposes of the present disclosure.

The camera which delivers the images which are to be reproduced on the display instrument 13 in the reproducing state should also then be placed adjacent to the display instrument 13 on the center console 11. Here, this can be the directable camera 10 shown in FIG. 1. However, a camera 14 may also be integrated fixedly into the center console 11, the view field of which camera is large enough to capture the driver 3 and front passenger 12 at the same time. Such an extremely wide-angled camera 14 indeed on the whole delivers strongly perspective distorted images, if however only a small section of these images, namely the head of the driver or of the front passenger, is enlarged from these images and reproduced on the display instrument 13, the distortion is not more noticeable than in the case of a lens with a small view angle, which is directed in a targeted manner to the head of the driver 3 or of the front passenger 12.

In the case of the directable camera 10, the activation of the reproducing state can take place in that a rotation of the camera 10 is detected. By means of the image then appearing on the display instrument 13 in the reproducing state, the user, whether driver 3 or front passenger 12, can direct the camera precisely on himself. A switch 15 for activating the reproducing state can also be placed directly on the housing of the camera 10, so that it is necessarily touched when directing the camera 10.

In the case of the camera 14, the view field of which includes driver 3 and front passenger 12, two switches can be provided, one in the reach of the driver and one in the reach of the front passenger, so that the image processing unit selects the head to be enlarged and presented from the images according to the switch which is actuated.

A switch can be dispensed with entirely if the image processing unit is arranged to detect a predetermined gesture by the driver 3 or front passenger 12 and, on recognition of the gesture, to switch into the reproducing state. Here, also, the decision as to which head is presented in the reproducing state can depend advantageously on which of the two persons has shown the gesture concerned, for example pointing to the camera 14 or approaching the camera 14 to below a predetermined threshold.

The camera 7, 10 or 14 and the display instrument 4, 13 according to the embodiments described above can be used advantageously additionally as parts of a video conference system, as illustrated in FIG. 2 by means of a block diagram. An image processing unit 16 which shows the functionalities of the image processing unit already mentioned above and also further functionalities which are to be explained in further detail below, forms the core of this video conference system. The image processing unit 16 is coupled to at least one camera 7, 10 or 14 for the capturing of driver and front passenger and at least one camera 17 for the capturing passengers on the rear seats of the vehicle.

Several microphones 18 are distributed in the passenger compartment, preferably one at each seat, in order to register the speech of the occupants and by means of in a time-delayed manner or sound level of the registered speech signals of the image processing unit 16 to enable an identification of the seat of a speaker, by means of this identification to select between the camera 7, 10 or respectively 14 allocated to the front seats and at least one camera 17 allocated to the rear seats, to enlarge the head of the speaker from the images delivered from the selected camera and to emit them to connected screens 19, which are mounted respectively in a readily visible manner in front of the occupants' seats.

Screens for the occupants on the rear seats can be advantageously set into the backrests of the front seats. The driver and front passenger can use the display instrument 13 of the center console as a shared screen 19. If the region 9 of the display instrument 4 functions as screen 19 for the driver, the image processing unit 16 here should also be coupled to a tachometer 20, in order to prevent the image reproduction in the region 9 when the speed of the vehicle exceeds a predetermined threshold speed.

In order to also enable use in the dark, the cameras 7, 10 or 17 of the example embodiments described above can be combined respectively with an IR light source, in particular an IR LED, which illuminates the field of view of the camera without dazzling the driver. In particular, this enables the front passenger to use the vanity mirror during the journey without, in so doing, irritating the driver.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. A dashboard display for a vehicle comprising:
a camera configured to be directed at least temporarily to an occupant of the vehicle; and
a display panel arranged on a dashboard, wherein the display is switchable from a display state for displaying at least one operating parameter of the vehicle and a reproducing state for displaying images delivered from the camera.

17. The dashboard display according to claim 16, wherein the camera is arranged adjacent to display panel.

18. The dashboard display according to claim 16, wherein the display panel is arranged in front of a driver's seat.

19. The dashboard display according to claim 16, wherein the at least one operating parameter displayed in the display state relate to the operation of the vehicle.

20. The dashboard display according to claim 16, wherein the display panel is arranged on a center section of the dashboard.

21. The dashboard display according to claim 20, wherein the display panel in the display state serves for the display of operating parameters of at least one of an infotainment system, a heating system, air-conditioning system or heating/ventilation/air conditioning system of the vehicle or a combination thereof.

22. The dashboard display according to claim 16, wherein the reproducing state activated only when the vehicle is travelling at a speed below a threshold speed.

23. The dashboard display according to claim 16, wherein the reproducing state activated only when the vehicle is stationary.

24. The dashboard display according to claim 16, further comprising a switch for activating the reproducing state.

25. The dashboard display according to claim 16, wherein the reproducing state is configured to be activated by touching the camera.

26. The dashboard display according to claim 16, further comprising an the image processing unit operably connected between the camera and the display panel and configured to detect an activation gesture by the occupant and, on detection of the activation gesture, to activate the reproducing state.

27. The dashboard display according to claim 27, wherein the activation gesture is an approach towards the display panel or towards the camera.

28. The dashboard display according to claim 16, further comprising an image processing unit operably connected between the camera and the display panel and configured to identify the head of the occupant and to deliver an image section which contains the head to the display panel.

29. The dashboard display according to claim 28, wherein the camera has a field of view configured to capture several occupants within the vehicle.

30. The dashboard display according to claim 29, wherein the image processing unit is configured to select a head from the several occupants within the field of view and to deliver an image section of the head to the display panel.

31. The dashboard display according to claim 16, wherein the camera is arranged in order to capture an occupant on a rear seat of the vehicle.

32. The dashboard display according to claim 31, further comprising at least one microphone for identifying a speaker from amongst the occupants, and with a decision unit configured to identify the speaker and to deliver an image of the speaker to the display panel.
